(19) United States
(12) Patent Application Publication
(10) Pub. No.: US 2011/0167014 A1
(43) Pub. Date: Jul. 7, 2011

(54) METHOD AND APPARATUS OF ADAPTIVE CATEGORIZATION TECHNIQUE AND SOLUTION FOR SERVICES SELECTION BASED ON PATTERN RECOGNITION

(75) Inventors: Liang-Jie Zhang, Yorktown Heights, NY (US); Abdul Allam, Durham, NC (US); Yi-Min Chee, Yorktown Heights, NY (US); Shuxing Cheng, Ames, IA (US); Qun Zhou, Hawthorne, NY (US)

(73) Assignee: INTERNATIONAL BUSINESS MACHINES CORPORATION, Armonk, NY (US)

(21) Appl. No.: 12/652,155

(22) Filed: Jan. 5, 2010

(51) Int. Cl. G06F 17/30; G06Q 99/00; G06F 3/048

(52) U.S. Cl. 705/347; 707/740; 707/E17.09; 707/748; 715/764

(57) ABSTRACT

A system and method for selecting services using adaptive categorization based on pattern recognition, in one aspect, group services registered in a plurality of service registries into a plurality of categories. A plurality of features associated with each category of services is defined and the services in each category are graded based on the defined features. A pattern recognition algorithm is used to cluster the services in each category based on the grades of the features. One or more selection criteria for services are further defined and the services are graded based on said selection criteria. A threshold value for each of the selection criteria is established, and one or more services that meet the threshold value are exposed.

### FIELD OF THE INVENTION

The present disclosure relates to service oriented architecture and more particularly to adaptive categorization technique and solution for services selection based on pattern recognition.

### BACKGROUND OF THE INVENTION

Service-oriented Architecture (SOA) provides a flexible and extensible architecture that supports dynamic adaptation of business processes and associated systems to support changing business strategies and tactics in the field of services computing. It enables enterprise system to be modeled in a business driven manner based on reusable assets. SOA design provides a competitive advantage by allowing new processes to be constructed based on services that are either existing ones or newly created ones.

Services discovery and services exposure are two components that enable services identification in a SOA design platform. However, there lacks a systematic research focusing on designing and developing industry applicable software tool that can help service system designer conduct services discovery and exposure.

In generic service domain, services are published to a public or private service registry, an electronic yellow page within which service requesters can search to find service providers and corresponding services they need. A company that plans to grow its business can publish the availability of its services to the service registry. In the near future, several thousands of distinct service entities are expected in various service registries. It is unlikely that searching for services providers and services that satisfy a particular set of criteria will yield a manageable set of results. To address this problem there is a need for an efficient services search engine for locating and further creating services instances to serve the request. Nevertheless, the current design for the service registry architecture lacks a well-organized categorical structure and service-aware exploration method that addresses the above concerns and enables effective real-time and offline services selection.

While some existing works have been conducted for the semantic Web services discovery using the ontology based technique and quality of service (QoS) ontology, those techniques do not focus on the systematic organization methodology that can help the service discovery process, for instance, by leveraging the pattern recognition theory.

### BRIEF SUMMARY OF THE INVENTION

A method and system for selecting services using adaptive categorization based on pattern recognition are provided. The method in one aspect may comprise grouping services registered in a plurality of service registries into a plurality of categories and defining a plurality of features associated with each category of services. The method may also include scoring the plurality of features associated with said each category of services; clustering said each category of services into a plurality of cluster of services, using a pattern recognition algorithm and based on the scores of the plurality of features. The method may yet further include defining one or more selection criteria for services in said each category of services and scoring each service in said each category of services based on said one or more selection criteria. The method still yet may include establishing one or more threshold values respectively associated with said one or more selection criteria; and exposing one or more services from said each category of services that have selection criteria that meet said one or more threshold values.

A system for selecting services using adaptive categorization based on pattern recognition, in one aspect, may comprise a processor; a user interface module operable to receive a plurality of features defined for a category of services and associated graded values associated with said plurality of features for each service in said category of services; and a services clustering module operable to cluster said each category of services into a plurality of cluster of services, using a pattern recognition algorithm and based on said graded values. The user interface module is further operable to receive one or more selection criteria defined for services in each of said plurality of cluster of services and associated scores. The services clustering module is further operable to establish one or more threshold values respectively associated with said one or more selection criteria and exposing one or more services from said each cluster of services that have selection criteria that meet said one or more threshold values.

A program storage device readable by a machine, tangibly embodying a program of instructions executable by the machine to perform methods described herein may be also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is an architectural diagram showing architecture for an enhanced services discovery engine with intelligent business services analyzer functionalities.

FIG. 2 is a flow diagram illustrating a method of the present disclosure in one embodiment.

FIG. 3 is a flow diagram illustrating a method of the present disclosure in further detail in on embodiment.

FIG. 4 shows a screen shot for the services categorization module implemented according to the present disclosure in one embodiment.

FIG. 5 is a screen shot illustrating an example of a pull down menu for defining features in the system that implements the methodology of the present disclosure in one embodiment.

FIGS. 6A, 6B, 6C show examples of launched criterion dialog.

FIG. 7 is an example of a GUI that illustrates selected features for a given service category.

FIG. 8 is an example of a GUI that illustrates a dialog for setting up scores for a given service.

FIG. 9 shows a 3-D plot for the service points distributed in the built feature space.

FIG. 10 shows the clustered result after launching the implemented clustering module.

FIG. 11 shows a GUI for deciding the selection criterion for services exposure step.

FIG. 12 shows a GUI for describing the service exposure weighting and setting up the associated threshold.

FIGS. 13A, 13B and 13C show the score for each service with respect to the decided criterion being set up in FIG. 11.

FIG. 14 illustrates an example of a GUI that shows the exposed service to serve the request.

### DETAILED DESCRIPTION

This disclosure proposes a methodology and enabling solution for intelligent business services analyzer that performs analyzing, clustering and adapting heterogeneous services. From a method perspective, a cascaded services exploration method comprising services categorization, services clustering and services exposure steps are presented. Services categorization, a formalized result of SOA design at business level, may be performed by business analysts. A manageable feature space is built to encode the still “big” service category containing large amount of services. Based on this built feature space, service clustering groups services into different sections by applying pattern recognition algorithm. This systematic solution aims to manage the originally “disorder and big” service repository in a controllable way. Services exposure refines the result of services clustering and exposes a selected set of services to serve the customer in an integrated SOA solution environment. The method of the present disclosure in one embodiment may be embodied as software or toolkit platform or like, executing systematic service exploration procedures on a computer processor. The pattern recognition based services clustering engine and GUI based customization interface may be integrated together to provide a flexible industry strength SOA services selection tool or system or like, in an organized SOA spectrum. The GUI based human assisted tune-up interface makes it very convenient for the services system designers to customize their design according to the adaptive system requirements.

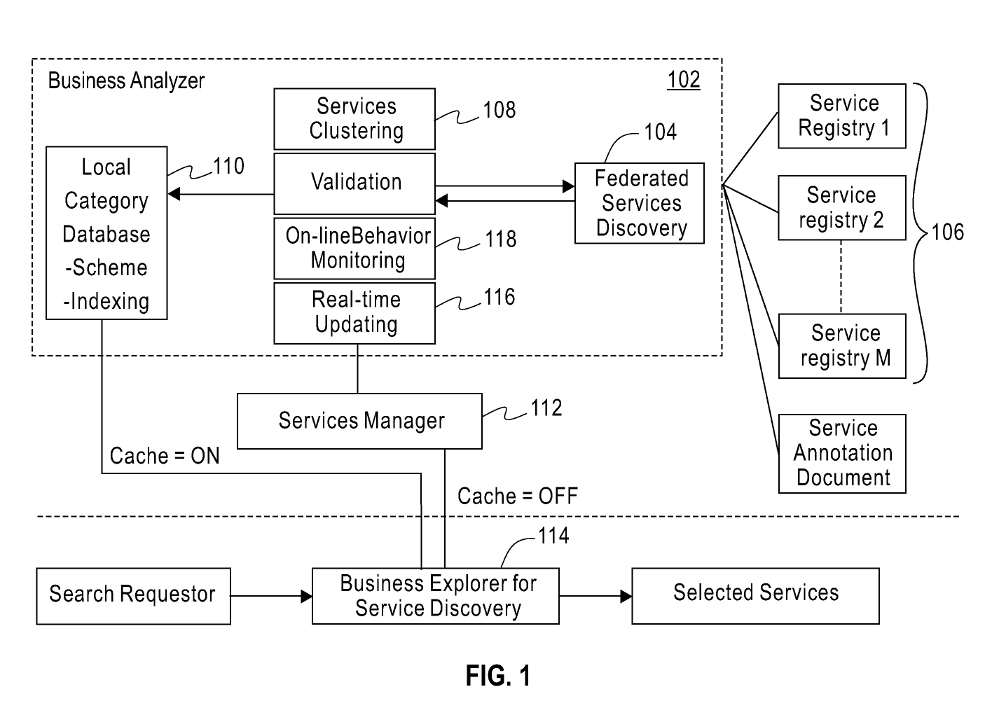

In another aspect, the present disclosure provides an architectural framework and enabling technology for a business services analyzer that supports analyzing, clustering and adapting heterogeneous services for dynamic application integration. FIG. 1 is an architectural diagram showing an enhanced services discovery engine 102 with intelligent business services analyzer functionalities. In a practical SOA design, candidate services may originate from two resources: the existing service assets owned by the enterprise and newly deployed services from vendors. All of these different services are stored in various service registries 106. Federated Service Discovery module 104 can discover services from both types of resources. The published category data from different service registries 106 can be leveraged or used by Services Clustering module 108. The data is used to create feature set of individual services to be used by the clustering algorithm in the service clustering module. A Local Category Database 110 is used to store and re-organize the services category based on the output of Services Clustering module 108. The Services Clustering module 108 groups the services into different clusters that can both help in building the indexing structure for the Local Category Database 110 and the Services Manager 112. Depending on whether the Cache is “ON” or “OFF”, Business Explorer for Service Discovery module 114 can query the candidate service from either Local Category Database 110 or Services Manager 112. If the cache is ON, the services information may be returned to the service requestor directly without going through the services registry. If the cache is OFF, each request from the service requestor is handled by communicating with the service registry.

Query candidate service means the request for a candidate service is done with the help of query based search request. Candidate service is stored in various services registries. In one embodiment, a query may be a XML based search request. The Services Clustering module 108 helps to accelerate the querying process. With respect to a given service query, the bottleneck of discovering the best fit within a limited time period is the massive amount of stored services. The method of the present disclosure in one embodiment addresses to reduce the original search domain to a smaller one by exploiting the structured information embedded in each service. At first, the method scans the classified service clusters based on the cluster tag. The scanning process returns a cluster whose tag displays a characteristic, which fits the best to the query among the listed clusters. Further, the method refines the search in the returned cluster to find the best candidate to serve the proposed query.

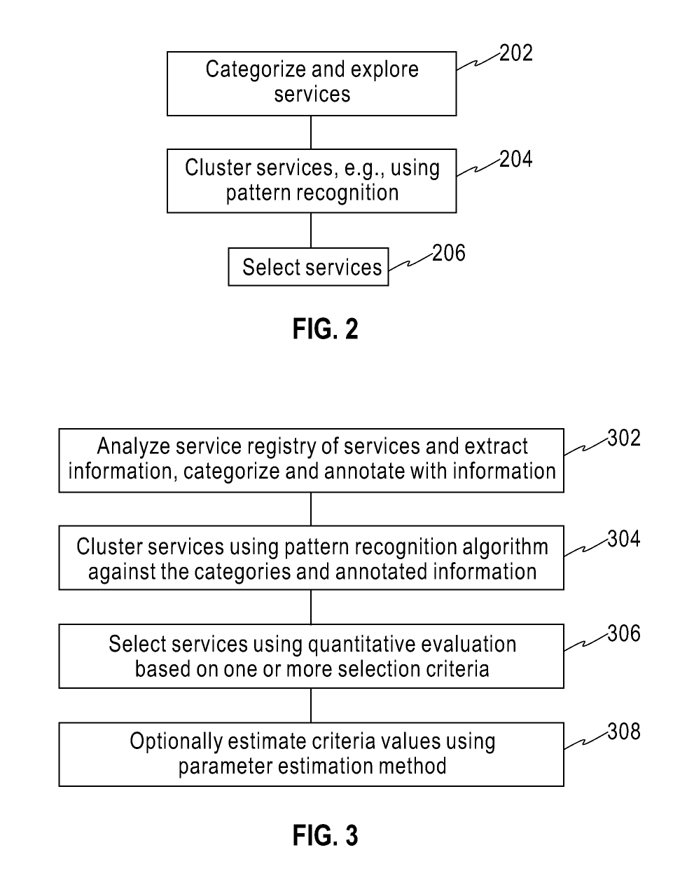

The present disclosure in one embodiment provides a unique design for the service clustering module 108. The service clustering module 108 in one embodiment may implement a cascaded services clustering approach. This approach provides a systematic methodology that can explore the stored services in a cascaded fashion. Formally, we name this methodology as Cascaded Services Exploration, which will be denoted as CSE for simplicity in the remainder of the disclosure. CSE in one embodiment may comprise three steps: services categorization, services clustering and services exposure. FIG. 2 is a flow diagram illustrating the above steps. Typically a published service is annotated with categorical information such as “this service is a payment service” or “this service is a shipping service”. This type of categorical information is submitted by service provider or dedicated agencies, and can be extracted easily from metadata associated with the service by service invoker who searches the service registry for available services. In the present disclosure, we assume the existence of categorical information. Accordingly, service registry can organize the registered service items in different categories at step 202.

The number of services belonging to each category can be still very large, which makes it quite difficult to produce manageable searching result in the lifecycle of SOA solution design. To address this problem, the methodology of the present disclosure in one embodiment further refines the organization of each category based on pattern recognition at step 204, which can help pinpoint the similarities and differences among different services according to a set of given features. The discovered similarities and differences are quantified into measurable distances in a so-called feature space. With the help of this quantifying process, the original fuzzy relationship among different services can be gauged and further extracted to specify the topological structure (pattern) embedded among a large amount of services. The creation of this type of topological structure can be used to cluster services into different groups, each of which is composed of a set of services, which are similar to each other based on the measurable distance associated with the feature space. Pattern recognition is a theory that formalizes this whole process based on a mathematically sound framework.

The potential usage of these service clusters is two faceted. First, for a given service request, discovery process is scoped in a particular cluster rather than the whole category. The selected cluster should match the requested service better than other clusters. Naturally, the number of candidate services belonging to a selected cluster can be much smaller than the number of candidate services included in a category. Second, the similarities among the services included in each cluster imply that a service can be used as a potential replacement for any other services belonging to the same cluster.

At step 206, the step of service exposure further refines the clustered services resulting from the second step. Using a customized set of service selection criteria defined by service system user or designer, the methodology can further expose services which can best fit the business requirement given by service user.

FIG. 3 is a flow diagram illustrating the above methods in more detail. At step 302, services in a service registry are categorized according to the business domain or business function(s) they provide, and annotated with additional information such as reliability, response time, quality of service, security, and organizational information about the service providers. Other information or attributes may be used to annotate the services. At step 304, the categorized services are further clustered, for example, applying a pattern recognition algorithm, on the annotated information (also referred to as “parameters”). At step 306, the services are selected to be included in the solution using a quantitative evaluation of the suitability of each service to the solution requirements. This evaluation ranks the services based on a set of selection criteria, for instance, specified by a service user or a third party expert. The services under consideration are provided by the output of the clustering step. An initial set of criteria can also be generated based on the results of the clustering step. At step 308, criteria values that are not present in the service registry annotations can be estimated by applying a parameter estimation method.

The following description illustrates services clustering based on pattern recognition. Clustering is a widely used technique to group data objects into different categories. These data objects include a set of features. A set includes one or more features. In one embodiment of the present disclosure, one or more features are used to put these data objects in a high-dimensional separable feature space where we can separate data points from each other. Generally, clustering comprises two phases: feature selection which is used to define features to build separable feature space; and the operation of grouping those data points distributed across the feature space based on clustering algorithms. Our proposed services clustering module includes the following steps in one embodiment:

Step 1: Services feature selection;
Step 2: Services clustering based on pattern recognition algorithm;
Step 3: Human-assisted tune-up.

Step 1 builds a manageable feature space that can be used by the clustering algorithm in the services clustering step. With respect to the services system design, each service is associated with several features, some of which are based on the customer requirement or real business scenario, while others are decided by the service content. In the services clustering, a clustering algorithm such as K-means clustering algorithm may be used to conduct the services clustering. The step of “human-assisted tune up” is a business oriented engineering effort that introduces expert knowledge into the services discovery process.

The following illustrates building feature space for services in one embodiment of the present disclosure. A service is not a concept that can be quantified easily. To cluster services, we extract some information from services that can be measured quantitatively at some degree so that we can count the difference and similarity among different services. In the generic service domain, we consider the following features of a service, which span across the lifecycle from the time instant of service requesting to the time instant of service fulfillment. The methodology of the present disclosure, however, does not limit the measures only to the following examples. Rather, other measures may be contemplated and utilized.

Services reliability: Services reliability measures the ability of a service to perform its published functions under certain conditions.

Services accessibility: Service accessibility is measured by the successful invocation rate or chance of a successful service instantiation at a certain time point. Services accessibility varies with the volume of services requests. A scalable services system has better services accessibility when serving large amount of requests simultaneously.

Services throughput: Services throughput represents the number of handled services requests with successful services delivery in a given time period.

Services latency: Services latency represents the response time between receiving a service request and finishing serving this request.

Services security: Services security is the quality aspect of the service that is served without losing any physical assets or privacy. For example, a secure shipping service should guarantee the delivery of package without damages.

Services cost: Services cost represents the price that is charged by the service provider.

Services interface: Services interface defines the services gateway for communicating with other services, which includes services data exchange standard and supporting communication protocols, etc.

Services state: Services state captures the dynamic information associated with a service. For example, the number of usage for a Stock Quota Service can vary over the time.

In summary, each studied service system is characterized by a feature set denoted as β_{T}={F¹,F², . . . , Fⁿ}.

The service features are extracted, for instance, from the information collected by the modules of “Real-time Updating” 116 and “On-line Behavior Monitoring” 118 in the services analyzer architecture shown in FIG. 1. Being an illustrative yet practical example, services reliability for a particular type of service can be computed as follows. In a given period of time, we count the number of total served requests, which is denoted as SRₜₒₜₐₗ; we also count the number of failures among SRₜₒₜₐₗ, which is denoted as SR_{fail}. Naturally, SR_{fail}<=SRₜₒₜₐₗ. We use P_{reliability}=(SRₜₒₜₐₗ−SR_{fail})/SRₜₒₜₐₗ to represent the services reliability. We can grade the computed ratio with a score in a “1-5” scale as shown in Table 1.

TABLE 1
Score for services reliability

| Range of P_{reliability} | The value of grade |
|---|---|
| P_{reliability} >= 0.9 | 5 |
| 0.8 <= P_{reliability} < 0.9 | 4 |
| 0.7 <= P_{reliability} < 0.8 | 3 |
| 0.5 <= P_{reliability} < 0.7 | 2 |
| P_{reliability} < 0.5 | 1 |

Other metrics such as services accessibility can be graded similarly. With respect to services throughput and services latency, the system maintains a database storing a historical record for throughput and latency. Comparing the values of current throughput and latency obtained by “On-line Behavior Monitoring” module with the historical record, we can get a view of how the service performs at present. Based on this comparison, we can also grade them in a numerical scale like “1-5”.

The services security can be quantified by the security level normally provided by the services provider, while the services cost can be graded based on the tradeoff between the realized services quality and the charged price. Overall, a quantifying procedure is launched to associate a feature with a numerical value, which characterizes the instance of a given service from the point of view of this particular feature.

Not all of the features can be quantified easily. Moreover, there exists some degree of uncertainty for specifying the grading values. Robust digitization techniques can be applied to quantify the features while handling the uncertainty as well. In the following example, we list three features as well as the numerical sphere for a given type of service. An instance of this type of service can be graded with a numerical value falling into this sphere.

TABLE 2
Feature-Value table

| Feature | Sphere for values |
|---|---|
| F₁: Services security | Min: 1 Max: 5 |
| F₂: Services cost | Min: 1 Max: 5 |
| F₃: Services latency | Min: 1 Max: 5 |

From the topological point of view, the feature set β_{T} defines a high dimensional feature space; the quantifying process associates each service with a point located in this feature space.

The step of services feature extraction as well as the quantifying process maps the quality aspects of each service into quantity values. The differences and similarities among different services in a topological space can be studied using mathematical techniques. For example, we can measure the difference between two services by computing the Euclidean distance of their associated points in the feature space.

$${D}_{{s}_{i} {s}_{j}} = \sqrt{{\sum }_{l = 1}^{n} {( {F}_{i}^{l} - {F}_{j}^{l} )}^{2}} \qquad Eq ( 1 )$$

In Eq (1), Sᵢ and Sⱼ represent two points respectively; and Sᵢ=Fᵢ¹Fᵢ² . . . Fᵢⁿ where Fᵢ^{l} represents the numerical value for the l-th feature of point Sᵢ; n represents that we have n features. Equation 1 illustrates how to compute the distance between two service instances.

Topologically, we can identify the embedded structure among these points by isolating clusters whose inter-point distances are smaller compared with the distance to points outside the cluster. The points being assigned to the same cluster imply that the associated services are near from the point of view of selected features. Several clustering algorithms have been developed to find the pattern for large amount of high-dimensional data. In our research, we apply K-means algorithm for clustering the services because of its simplicity in the implementation and satisfactory clustering performance. Assuming that we have M service points, each is represented as x, where i=1 . . . M; and K clusters. The value of K is prior information for the K-means algorithm. In reality, the value of K can be decided based on the studied problem itself or computed by some pre-processing procedures. Each cluster Cⱼ is represented by a functional nucleus point denoted as uⱼ, which can be computed as follows:

uⱼ=uⱼ¹uⱼ² . . . uⱼⁿ

uⱼ^{t}=f(Fₗ^{t}, . . . , Fᵢ^{t}, . . . F_{∥C}_{ⱼ}_{∥}^{t}) Eq(2)

In the above equation, uⱼ^{t} represents the numerical value for the t-th feature of uⱼ, ∥Cⱼ∥ represents the number of points included in the cluster Cⱼ; Fₗ^{t} represents the numerical value for the t-th feature of the l-th point in the cluster Cⱼ. f( ) is a function that computes the functional nucleus point. For example, the functional nucleus point can be computed as follows.

$${u}_{j}^{t} = \frac{{\sum }_{l = 1}^{‖ {C}_{j} ‖} {F}_{l}^{t}}{‖ {C}_{j} ‖} \qquad Eq ( 3 )$$

Given a combination of a set of services points and a particular cluster allocation, we can compute the clustering performance accordingly.

$$J = {\sum }_{i = 1}^{M} {\sum }_{j = 1}^{K} {a}_{ij} ‖ {x}_{i} - {u}_{j} ‖ \qquad Eq ( 4 )$$

In Eq (4), ∥xᵢ−uⱼ∥ denotes the distance between the service x, and functional nucleus point uⱼ of cluster Cⱼ; aᵢⱼ is called cluster allocation variable,

aᵢⱼ=1 if xᵢ∈Cⱼ

aᵢⱼ=0 if xᵢ∉Cⱼ Eq (5)

K-means algorithm comprises two steps, E-Step and M-Step. E-Step is to solve the following optimization problem:

aᵢⱼ=arg min(J), ∀i=1 . . . M, j=1 . . . K Eq(6)

where uⱼ is fixed ∀j=1 . . . K

M-Step is to solve the following optimization problem:

uⱼ=arg min(J), ∀j=1 . . . K Eq(7)

where aᵢⱼ is fixed ∀i=1 . . . M, j=1 . . . K

The optimization problem associated with E-Step can be solved easily because it can be decomposed into n independent optimization problems. The optimization problem associated with M-step can be solved by launching Robbins-Monro procedure. More details about K-means algorithm can be found in C. M. Bishop, Pattern Recognition and Machine learning, Springer, 2006; R. O. Duda, P. E. Hart and D. G. Stork, Pattern Classification, Wiley-Interscience, 2000; and S. Theodoridis and K. Koutroumbas, Pattern Recognition, Academic Press, 2006.

Practically, both the K-means clustering method and other existing statistics based clustering methods may not totally replace the tune-up procedure based on the expert knowledge and specific problem requirements. In the present disclosure in one embodiment, we implement GUI based tune-up interface that can allow the users to change the clustering result according to the pre-known expertise. This is reflected by the step of “human-assisted tune up” listed in the CSE methodology.

The clustered services can be used as the basis for the further service selection. As shown in FIG. 1, Service Clustering module 108 guides the building of a well-organized “Local Category Database” 110 and a “Services Manager” 112, which can directly benefit the discovery process executed by “Business Explorer” module 114. Business Explorer is positioned as a comprehensive module that covers the lifecycle starting at service requesting while ending at service delivery, which includes not only on-line procedures like service discovery but also contains those off-line procedures such as service clustering and local category database building. The current services discovery setting requires to launch a global discovery process among all the candidate services for a given service request. Under the CSE guided framework, we refine our search in a particular cluster which are the most similar to the given service request. Each cluster can be represented using the functional nucleus point defined in Eq(2). The distance between a cluster and a particular service request is represented as the distance between the functional nucleus point and a requested service point in the built feature space.

We iterate over all the K clusters; compute the distance between the functional nucleus point of each cluster and the requested service. The cluster holding the smallest distance with the requested service contains the potentially exposed service to satisfy the customer's request. We denote the smallest distance as d, which satisfies the following equation, where K is the number of clusters,

$$d = min ( {∀}_{t = 1 … K} \sqrt{{\sum }_{j = 1}^{n} {( {F}_{t}^{j} - {F}_{r}^{j} )}^{2}} ) \qquad Eq ( 8 )$$

In the Eq 8, Fₜ^{j} represents the numerical value for the j-th feature of the function nucleus point for the t-th cluster; Fᵣ^{j} represents the numerical value for the j-th feature of requested service “xᵣ”.

Not all of the services may have a complete set of features required by the process of feature selection. For example, a particular service provider may decline to provide the security related information. This type of missing value problem can occur due to instrumental failure, observing limitation or other real-world problems. A robust clustering scheme based on EM algorithm, which can cluster data sets with missing values by estimating model parameters using maximum likelihood estimation technique (MLE), can be used to make up for the missing value problem. Such techniques are described in Z. Ghahramani and M. I. Jordan, “Supervised learning from incomplete data via the EM approach”, Advances in Neural Information Processing Systems, San Mateo, Calif., 1994; and G. Casella and R L. Berger, Statistical Inference, Duxbury Press, 2001. Moreover, every feature may not be necessarily treated equally. Under some scenarios, some features may have higher priority level than others. This type of priority information can be accounted for by adding weight to each feature. For a high-priority feature, we can add a larger weight; otherwise, we can add a smaller weight. These added weights adapt the effects of different features in the clustering result to their respective priority level.

The above-described methodology may be embodied or implemented as a toolkit or a software system or platform that guides the user automatically through the service discovery process. The software system or platform may comprise graphical user interface that guide and allow the user to input various parameters as the system performs the discovery process.

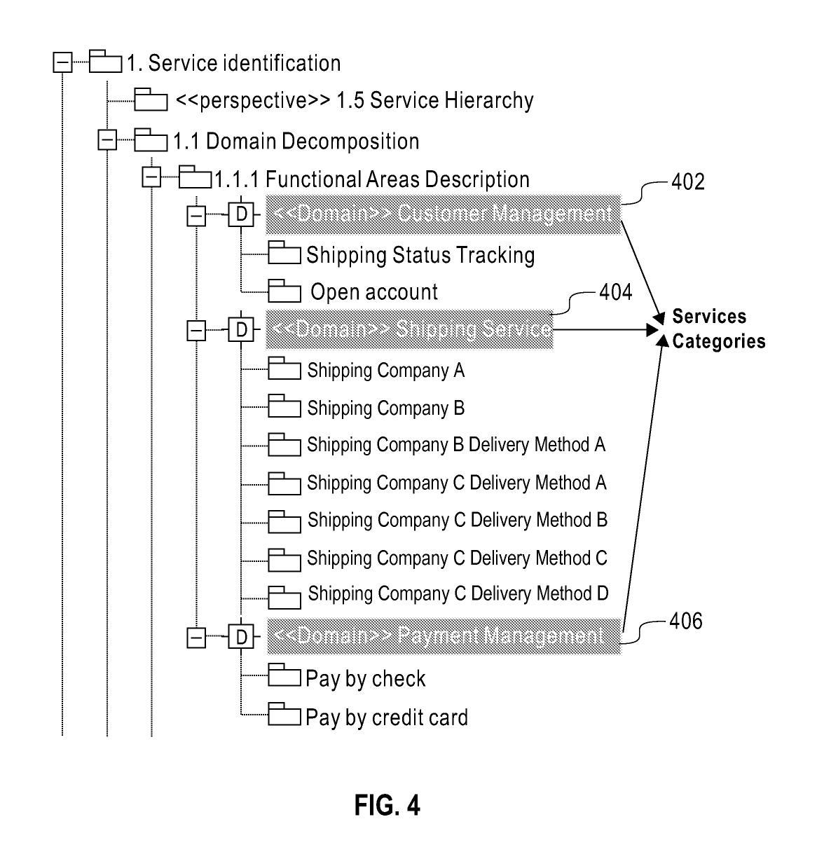

A SOA shipping services system design that implements the CSE methodology to perform the services discovery process is described. FIG. 4 shows a screen shot for the services categorization module implemented according to the present disclosure in one embodiment. After the system performs the categorization and annotation steps automatically, the system may present to the user a GUI such as the one shown in FIG. 4. This example illustrates three major categories (which is denoted as “Domain”): “Customer Management” 402, “Shipping Service” 404 and “Payment Management” 406. The available services having similar functionalities can be placed into the same category.

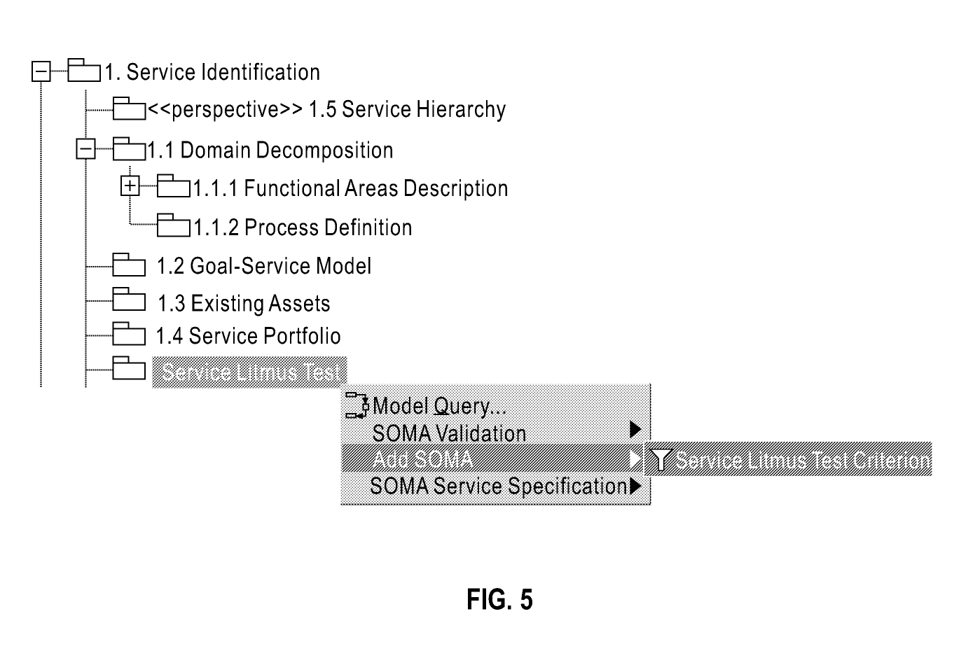

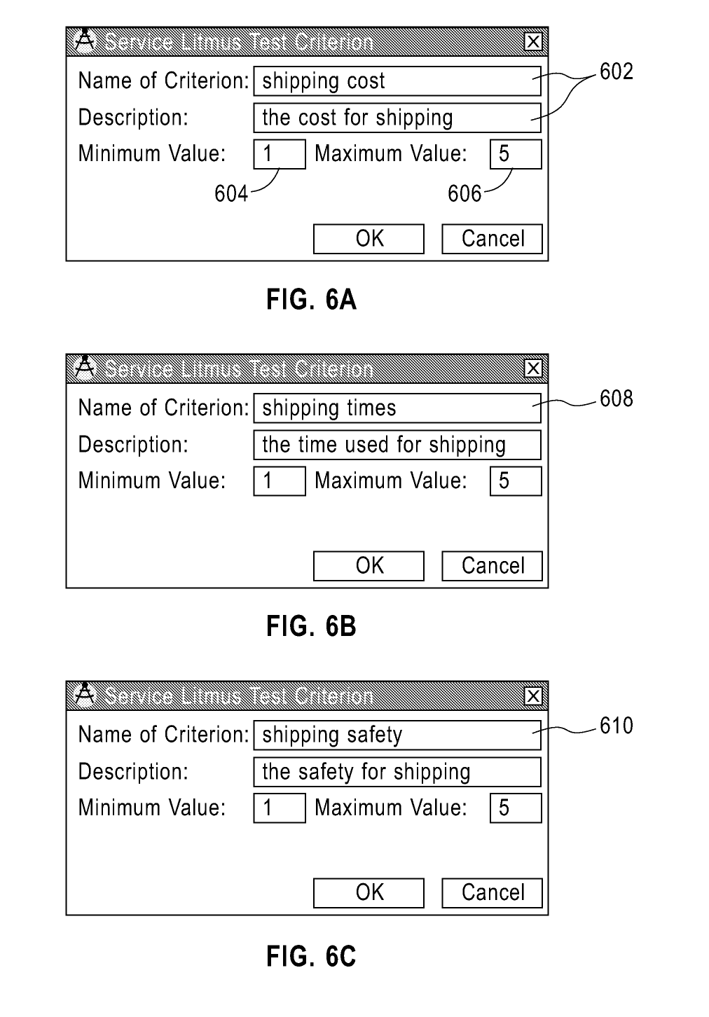

In the next part, the description focuses on the category of “shipping service” 404 to illustrate the workings of the methodology of the present disclosure in one embodiment. In general, there are three features that can be used to characterize the shipping services. In reality, the requirements of service customers represent the main resource to build a service feature set. By analyzing the stored service history and other available market resources, we can generate a requirement list proposed by the service customers. These requirements include attributes that can be used to characterize a service. On the other hand, service provider can also contribute some distinguishable features which are not covered by the customer's requirement. In this example, we use three features which are “shipping cost”, “shipping times” and “shipping safety”. In our design, a systematic services features building process is facilitated by launching the procedure of “Service Litmus Test (SLT) Criterion”, which is shown in FIG. 5. The design of SLT criterion dialog aims to provide guidance for specifying the selected services features as well as their physical descriptions and numerical range, which are illustrated in FIGS. 6A, 6B and 6C. In FIG. 6A, the selected service feature is called “shipping cost” 602. The item of “Description” 604 can be used to add some description to the selected feature, which can help customer or the system designer to document the design process. The “Minimum Value” 606 corresponds to the minimum numerical score assigned to the feature of “shipping cost”; the “Maximum Value” 608 corresponds to the maximum numerical score assigned to the feature of “shipping cost”. This numerical range is assigned by service solution designer based on his knowledge extracted from the real time as well as stored market information. Both the “Minimum Value” and the “Maximum Value” constitute the numerical sphere listed in Table 2.

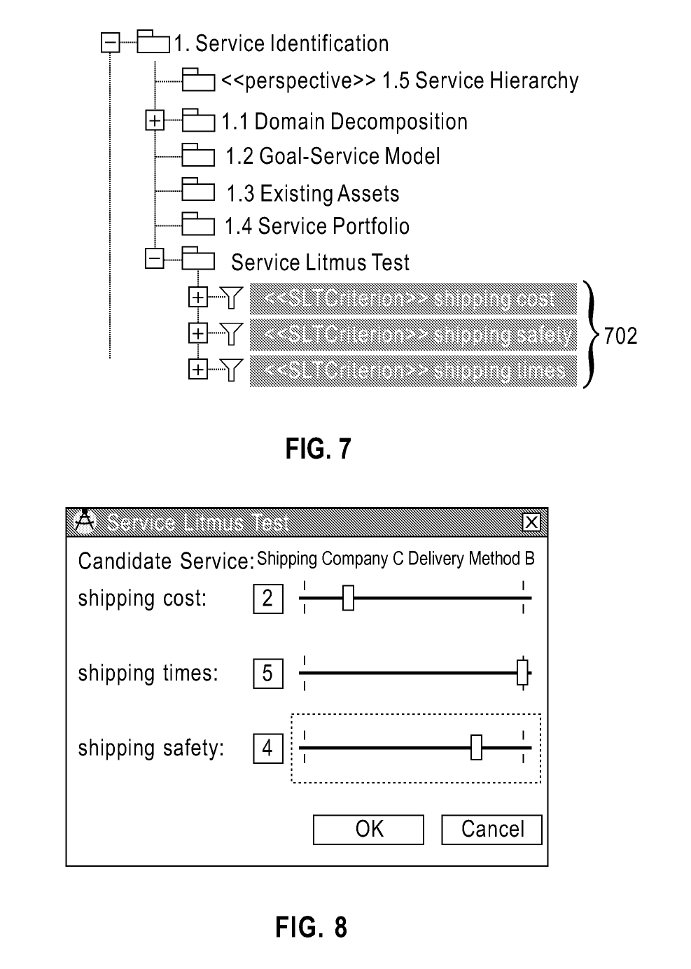

Similarly, in this example, we set up two other features. One is “shipping times” 610, another is “shipping safety” 612. The feature of “Shipping times” reflects how fast the package can arrive at the destination using the corresponding service. The feature of “Shipping safety” reflects how secure the shipped package can arrive at the destination without losing any physical or non-physical assets. FIGS. 6A, 6B and 6C illustrate a GUI-based feature selection procedure that builds a 3-D (three dimensional) feature space while the minimum and maximum values combined together to determine the sphere of this space. These selected features are automatically placed under a directory, for example, the Service Litmus Test directory, which is shown in FIG. 7. FIG. 7 is an example of a GUI that illustrates selected features for a given service category 702.

After selecting features, we decide the numerical values for each feature by assigning a grade to each feature. A GUI based interface is designed to allow the user to assign each feature with a numerical value for the service of “Shipping Company C Delivery Method B”, which is displayed in FIG. 8. FIG. 8 is an example of a GUI that illustrates a dialog for setting up scores for a given service. A user may grade the feature of “shipping cost” with 2 because of the incurred high cost of using this service. Similarly, a user may set up a score of 5 for the feature of “shipping times” because of its efficient shipping process; a user may setup a score of 4 for the feature of “shipping safety”.

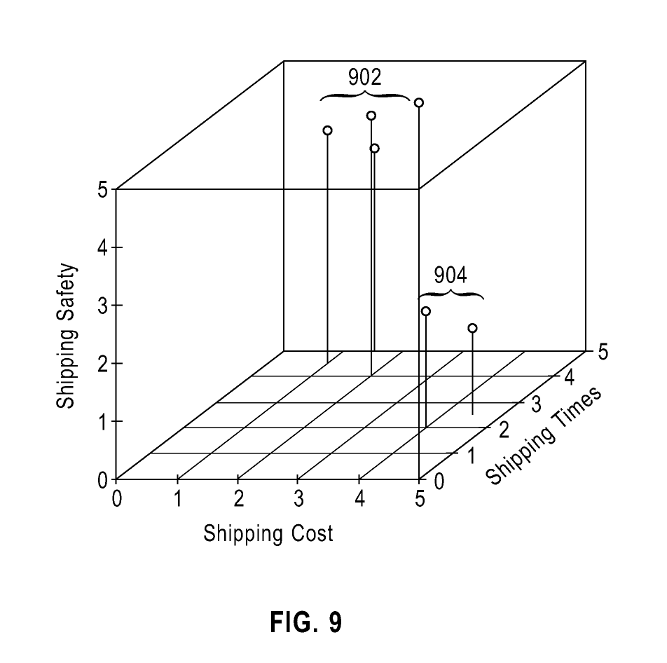

Similarly, we can assign grades to other services (e.g., Shipping Company A, Shipping Company B, Shipping Company C Delivery Method C, Shipping Company C Delivery Method A, Shipping Company C Delivery Method D, shown in FIG. 4) in the same “shipping service” category. FIG. 9 shows a 3-D plot for the service points distributed in the built feature space based on the score value having been assigned to each of them. It shows that four of the service points 902 have a more coherent structure while the other two 904 are closer to each other.

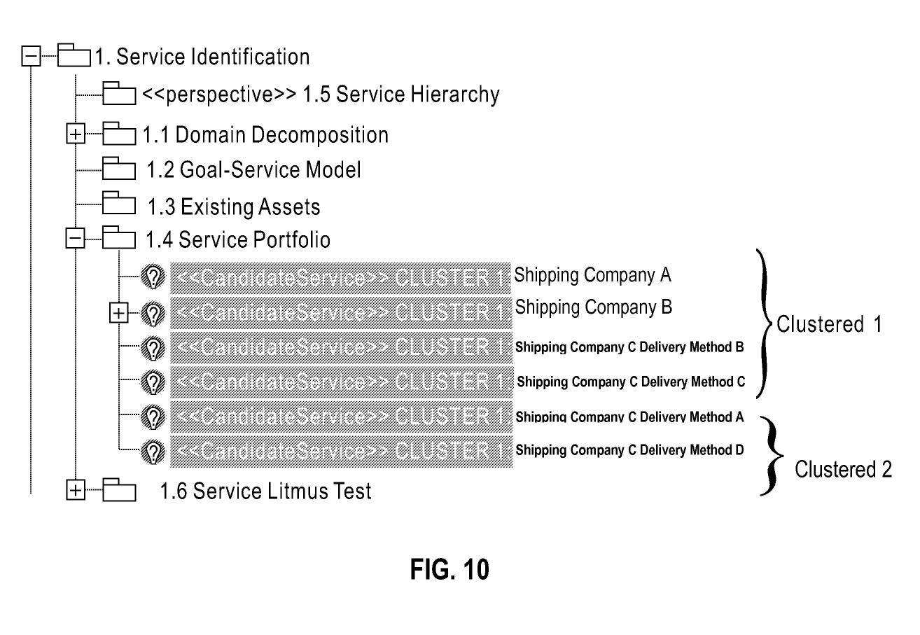

In one embodiment, a service clustering module, for example, based on the K-means algorithm may be implemented in the SLT software or tool or like. This module assigns a cluster label to each service. FIG. 10 shows the clustered result after launching the implemented clustering module. Each service is associated with a cluster label. To illustrate the clustering result, the SLT software or tool or like implementing the method of the present disclosure in one embodiment may mark each service with the computed cluster label, which is shown in FIG. 10. For this example, there are two clusters: cluster 1 and cluster 2. Cluster 1 includes the services, which charge more and ship faster; Cluster 2 includes the services that charge less and ship slower.

If the requested service puts high priority on the service's efficiency, then cluster 1 will be the one that has a smaller distance with this particular request. Therefore, cluster 1 is selected as the input for the step of services exposure, which is to finalize the selected service from the chosen cluster. As mentioned in the above, service exposure is to select a service from the selected cluster and expose it for deployment.

The step of service exposure may depend on a criterion to select the service that will serve the request the best. This criterion can be different with the selected features used in the services clustering. A wizard tool, for example, a “Service Litmus Test Criterion” setup wizard may be used to define the refined feature used in the step of “services exposure”.

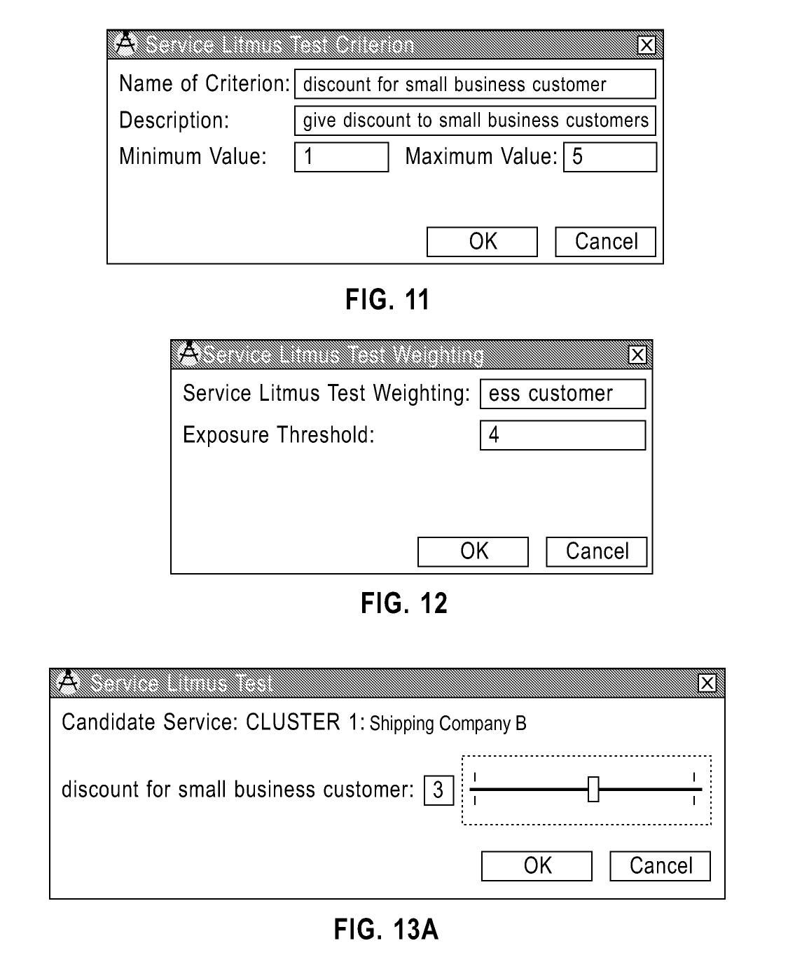

FIG. 11 shows a GUI for deciding the selection criterion for services exposure step. In this example, the shipping service is selected, which can provide discount for small business customer. Based on the amount of given discount, a user can grade each service in a scale of “1-5”.

Further, the user may decide a threshold for exposing the service, which can be setup in another GUI, for example, the “Service Litmus Test Weighting” wizard, shown in FIG. 12. FIG. 12 shows a GUI for setting up service exposure weighing and threshold. In FIG. 12, the user may setup the service exposure weighting, where we have single criterion only, which is “discount for small business customer”. The threshold is 4, which implies that if any candidate service in the cluster 1 is assigned a score being bigger than 4, then it can be exposed to serve the request.

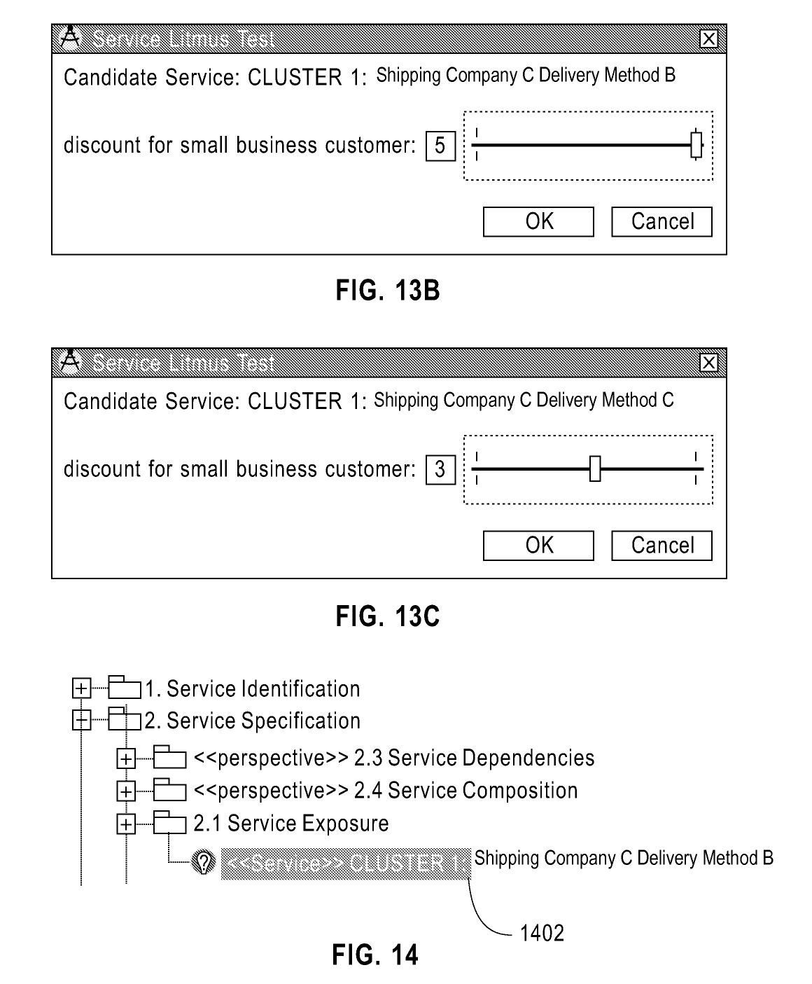

A GUI based functional module is implemented in the SLT software to allow the user to grade each service based on the selected criterion and particular characteristics of each service. FIGS. 13A, 13B and 13C show the grade for each service with respect to the decided criterion set up in FIG. 11. The service of “Shipping Company C Delivery Method B” gives more discounts to the small business customer than other services. Its score is setup as 5, which is bigger than the threshold of “4”. Therefore, the tool implementing the methodology of the present disclosure in one embodiment will automatically expose the service of “Shipping Company C Delivery Method B” into the service exposure package, which is shown in the FIG. 14.

FIG. 14 illustrates an example of a GUI that shows the exposed service to serve the request. FIG. 14 implies that the service of “Shipping Company C Delivery Method B” 1402 will be exposed to serve the request. In one aspect, the finally selected services to serve the request may be stored under the directory of “Service Exposure” 1404. For example, these services are the output of “Business Explorer for Service Discovery” module of the proposed architecture shown in FIG. 1.

A systematic cascaded services exploration methodology of the present disclosure seeks to enhance the current services discovery engine. The services clustering algorithm used in the present disclosure is based on the pattern recognition theory. Software, tool, or like may implement the methodology of the present disclosure in one embodiment. The methodology of the present disclosure and/or the tool that implements the methodology can be a very useful platform for the services system designer to cluster the services based on a specified feature space. This approach helps to reduce the number of candidate services for the final service exposure decision.

Various aspects of the present disclosure may be embodied as a program, software, or computer instructions embodied in a computer or machine usable or readable medium, which causes the computer or machine to perform the steps of the method when executed on the computer, processor, and/or machine.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A computer-implemented method for selecting services using adaptive categorization based on pattern recognition, comprising:
grouping services registered in a plurality of service registries into a plurality of categories;
defining a plurality of features associated with each category of services;
scoring said plurality of features associated with said each category of services;
clustering said each category of services into a plurality of cluster of services, using a pattern recognition algorithm and based on said scores of said plurality of features; and
defining one or more selection criteria for services in said each category of services and grading each service in said each category of services based on said one or more selection criteria;
establishing one or more threshold values respectively associated with said one or more selection criteria; and
exposing one or more services from said each category of services that have selection criteria that meet said one or more threshold values.

2. The method of claim 1, further including:
selecting a cluster from said plurality of cluster of services, that meet a predetermined criterion, before said step of defining one or more selection criteria; and
said step of defining one or more selection criteria and said step of establishing one or more threshold values are performed for one or more services in said selected cluster.

3. The method of claim 1, wherein said clustering step includes using K-means clustering algorithm.

4. The method of claim 1, wherein said clustering step includes discovering similarities and differences of said services based on said plurality of features quantified into measurable distances in a feature space.

5. The method of claim 1, further including:
replacing said exposed service with an alternative service selected from a category that said exposed services belongs to.

6. The method of claim 1, wherein said step of defining a plurality of features include:
presenting a graphical user interface; and
prompting a user to enter said plurality of features.

7. The method of claim 1, wherein said step of defining one or more selection criteria include:
presenting a graphical user interface; and
prompting a user to enter said one or more selection criteria.

8. The method of claim 1, wherein at least one of said plurality of features is associated with a customer requirement.

9. The method of claim 1, wherein at least one of said plurality of features is associated with a business criterion.

10. The method of claim 1, wherein said plurality of features includes reliability, accessibility, throughput, latency, security, cost, interface, or state, or combinations thereof, associated with services.

11. The method of claim 1, wherein said step of scoring said plurality of features includes quantifying said plurality of features based on historical data associated with said services.

12. The method of claim 1, further including:
assigning a weight to each of said plurality of features; and
said step of clustering further includes using said weight assigned to each of said plurality of features to cluster said services.

13. The method of claim 1, further including:
storing said clusters.

14. The method of claim 1, further including:
monitoring online behavior of said services; and
using results of said monitoring to score said plurality of features.

15. A system for selecting services using adaptive categorization based on pattern recognition, comprising:
a processor;
a user interface module operable to receive a plurality of features defined for a category of services and associated graded values associated with said plurality of features for each service in said category of services; and
a services clustering module operable to cluster said each category of services into a plurality of cluster of services, using a pattern recognition algorithm and based on said graded values,
said user interface module further operable to receive one or more selection criteria defined for services in each of said plurality of cluster of services and associated scores, said services clustering module further operable to establish one or more threshold values respectively associated with said one or more selection criteria and exposing one or more services from said each cluster of services that have selection criteria that meet said one or more threshold values.

16. The system of claim 15, further including:
a storage device operable to store said plurality of clusters.

17. The system of claim 15, wherein said clustering algorithm includes K-means clustering algorithm.

18. The system of claim 15, further including:
an on-line behavior monitoring module operable to monitor behavior of said services, wherein said graded values are based on said monitoring.

19. A program storage device readable by a machine, tangibly embodying a program of instructions executable by the machine to perform a method of selecting services using adaptive categorization based on pattern recognition, comprising:
grouping services registered in a plurality of service registries into a plurality of categories;
defining a plurality of features associated with each category of services;
scoring said plurality of features associated with said each category of services;
clustering said each category of services into a plurality of cluster of services, using a pattern recognition algorithm and based on said scores of said plurality of features; and
defining one or more selection criteria for services in said each category of services and scoring each service in said each category of services based on said one or more selection criteria;
establishing one or more threshold values respectively associated with said one or more selection criteria; and
exposing one or more services from said each category of services that have selection criteria that meet said one or more threshold values.

20. The program storage device of claim 19, further including:
selecting a cluster from said plurality of cluster of services, that meet a predetermined criterion, before said step of defining one or more selection criteria; and
said step of defining one or more selection criteria and said step of establishing one or more threshold values are performed for one or more services in said selected cluster.

21. The program storage device of claim 19, wherein said clustering step includes using K-means clustering algorithm.

22. The program storage device of claim 19, wherein said clustering step includes discovering similarities and differences of said services based on said plurality of features quantified into measurable distances in a feature space.

23. The program storage device of claim 19, further including:
replacing said exposed service with an alternative service selected from a category that said exposed services belongs to.

24. The program storage device of claim 19, wherein said step of defining a plurality of features include:
presenting a graphical user interface; and
prompting a user to enter said plurality of features.

25. The program storage device of claim 19, wherein said step of defining one or more selection criteria include:
presenting a graphical user interface; and
prompting a user to enter said one or more selection criteria.
